(19) United States
(12) Patent Application Publication
(10) Pub. No.: US 2017/0132097 A1
(43) Pub. Date: May 11, 2017

(54) POWER SUPPLY APPARATUS WITH REVERSE CURRENT PROTECTION AND REDUNDANT POWER SUPPLY SYSTEM

(71) Applicant: Chicony Power Technology Co., Ltd., New Taipei City (TW)

(72) Inventors: Chun-Hsiung WANG, New Taipei City (TW); Kai-Ming CHEN, New Taipei City (TW); Shing-Feng YANG, New Taipei City (TW)

(21) Appl. No.: 14/934,699

(22) Filed: Nov. 6, 2015

(51) Int. Cl. G06F 11/20; G06F 1/30

(52) U.S. Cl. CPC G06F 11/2015; G06F 1/30; G06F 2201/805; G06F 2201/81

(57) ABSTRACT

A power supply apparatus with reverse current protection includes a digital signal processor, a secondary side rectifying circuit, a voltage detection unit and a current detection unit. A plurality of the power supply apparatuses are connected in parallel and applied to a server system. When the voltage detection unit detects that a bus voltage is greater than a predetermined voltage and the current detection unit detects that an output current is less than a predetermined current, the voltage detection unit and the current detection unit inform the digital signal processor that the bus voltage is greater than the predetermined voltage and the output current is less than the predetermined current respectively, so that the digital signal processor turns off the secondary side rectifying circuit to stop outputting power.

### BACKGROUND OF THE INVENTION

Field of the Invention

The present invention relates to a power supply apparatus and a power supply system, and especially relates to a power supply apparatus with reverse current protection and a redundant power supply system.

Description of the Related Art

Currently, when power supplies are applied to a server system, a plurality of the power supplies are connected in parallel. This is the concept of backup power (redundant power). When the outputs of the power supplies are connected together, if one of the power supplies fails, the other normal power supplies cannot be used either. Therefore, usually an OringFet circuit is arranged in the power supply to avoid the failure of the bus voltage of the server system. The OringFet circuit can also avoid generating the reverse current with a greater peak value. However, the circuit cost of the power supply having the OringFet circuit is increased, and the power consumption is increased.

### SUMMARY OF THE INVENTION

In order to solve the above-mentioned problems, an object of the present invention is to provide a power supply apparatus with reverse current protection.

In order to solve the above-mentioned problems, another object of the present invention is to provide a redundant power supply system.

In order to achieve the object of the present invention mentioned above, the power supply apparatus comprises a digital signal processor, a secondary side rectifying circuit, a voltage detection unit and a current detection unit. The secondary side rectifying circuit is electrically connected to the digital signal processor. The voltage detection unit is electrically connected to the digital signal processor and the secondary side rectifying circuit. The voltage detection unit detects a bus voltage. The current detection unit is electrically connected to the digital signal processor, the secondary side rectifying circuit and the voltage detection unit. When the voltage detection unit detects that the bus voltage is greater than a predetermined voltage and the current detection unit detects that an output current is less than a predetermined current, the voltage detection unit and the current detection unit inform the digital signal processor that the bus voltage is greater than the predetermined voltage and the output current is less than the predetermined current respectively, so that the digital signal processor turns off the secondary side rectifying circuit to stop outputting power.

In order to achieve the object of the present invention mentioned above, the redundant power supply system comprises a plurality of power supply apparatuses with reverse current protection. The power supply apparatuses are connected in parallel and have a bus voltage and together output a direct current power. The power supply apparatus comprises a digital signal processor, a secondary side rectifying circuit, a voltage detection unit and a current detection unit. The secondary side rectifying circuit is electrically connected to the digital signal processor. The voltage detection unit is electrically connected to the digital signal processor and the secondary side rectifying circuit. The voltage detection unit detects the bus voltage. The current detection unit is electrically connected to the digital signal processor, the secondary side rectifying circuit and the voltage detection unit. When one of the power supply apparatuses is abnormal, an output voltage of the power supply apparatus becomes greater (namely, is increased), so that the bus voltage is increased continuously. When the voltage detection unit of the normal power supply detects that the bus voltage is greater than a predetermined voltage and the current detection unit detects that an output current is less than a predetermined current, the voltage detection unit and the current detection unit inform the digital signal processor that the bus voltage is greater than the predetermined voltage and the output current is less than the predetermined current respectively, so that the digital signal processor turns off the secondary side rectifying circuit, so that the normal power supply apparatus stops outputting power.

The advantage of the present invention is that when the bus voltage is greater than the predetermined voltage and the output current is less than the predetermined current, the digital signal processor turns off the secondary side rectifying circuit to stop outputting power to avoid the influence from the abnormal power supply apparatus.

### BRIEF DESCRIPTION OF DRAWING

FIG. 1 shows a block diagram of the power supply apparatus of the present invention.

FIG. 2 shows a circuit diagram of the secondary side rectifying circuit of the power supply apparatus of the present invention.

FIG. 3 shows a circuit diagram of the synchronous rectifying circuit of the power supply apparatus of the present invention.

FIG. 4 shows a circuit diagram of the secondary side rectifying driving unit of the power supply apparatus of the present invention.

FIG. 5 shows a circuit diagram of the isolation gate driver of the power supply apparatus of the present invention.

FIG. 6 shows a block diagram of an embodiment of the redundant power supply system of the present invention.

### DETAILED DESCRIPTION OF THE INVENTION

Please refer to following detailed description and figures for the technical content of the present invention. The following detailed description and figures are referred for the present invention, but the present invention is not limited to it.

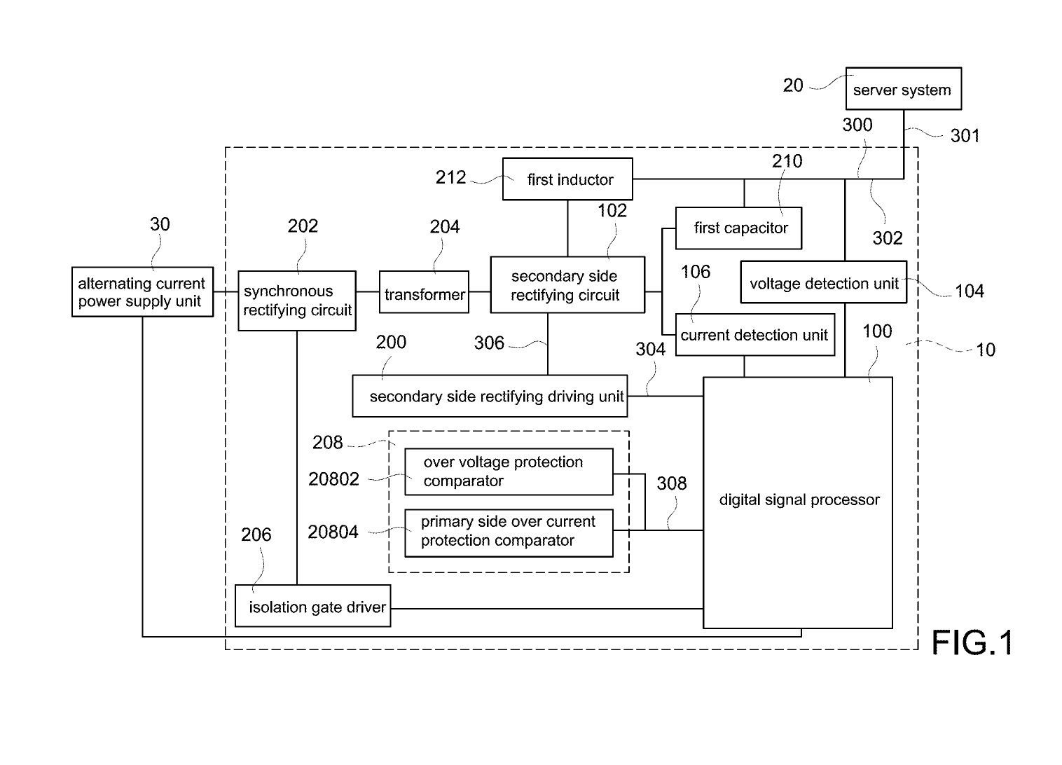

FIG. 1 shows a block diagram of the power supply apparatus of the present invention. A power supply apparatus 10 with reverse current protection is applied to a server system 20. The power supply apparatus 10 comprises a digital signal processor 100, a secondary side rectifying circuit 102, a voltage detection unit 104, a current detection unit 106, a secondary side rectifying driving unit 200, a synchronous rectifying circuit 202, a transformer 204, an isolation gate driver 206, a current protection circuit 208, a first capacitor 210 and a first inductor 212.

The secondary side rectifying circuit 102 is electrically connected to the digital signal processor 100. The voltage detection unit 104 is electrically connected to the digital signal processor 100 and the secondary side rectifying circuit 102. The current detection unit 106 is electrically connected to the digital signal processor 100, the secondary side rectifying circuit 102 and the voltage detection unit 104. The secondary side rectifying driving unit 200 is electrically connected to the digital signal processor 100 and the secondary side rectifying circuit 102. The transformer 204 is electrically connected to the secondary side rectifying circuit 102 and the synchronous rectifying circuit 202. The isolation gate driver 206 is electrically connected to the digital signal processor 100 and the synchronous rectifying circuit 202. The current protection circuit 208 is electrically connected to the digital signal processor 100. The first capacitor 210 is electrically connected to the secondary side rectifying circuit 102, the voltage detection unit 104 and the current detection unit 106. The first inductor 212 is electrically connected to the secondary side rectifying circuit 102, the voltage detection unit 104 and the first capacitor 210.

The alternating current power supply unit 30 sends an electrical power to the transformer 204 through the synchronous rectifying circuit 202. The transformer 204 transforms (processes) the electrical power to obtain a transformed electrical power. The transformer 204 sends the transformed electrical power to the secondary side rectifying circuit 102 to output power. The voltage detection unit 104 detects a bus voltage 300 and an output voltage 301.

When a plurality of the power supply apparatuses 10 are connected in parallel, if the voltage detection unit 104 detects that the bus voltage 300 (for example, 14 volts) is greater than a predetermined voltage (for example, 13 volts) and the current detection unit 106 detects that an output current 302 (for example, 0.1 A) is less than a predetermined current (for example, 0.5 A), the voltage detection unit 104 and the current detection unit 106 inform the digital signal processor 100 that the bus voltage 300 is greater than the predetermined voltage and the output current 302 is less than the predetermined current respectively, so that the digital signal processor 100 sends a first informing signal 304 to the secondary side rectifying driving unit 200. After the secondary side rectifying driving unit 200 receives the first informing signal 304, the secondary side rectifying driving unit 200 turns off the secondary side rectifying circuit 102 to stop outputting power.

When the voltage detection unit 104 detects that the bus voltage 300 (for example, 12 volts) is less than or equal to the predetermined voltage (for example, 13 volts), the voltage detection unit 104 informs the digital signal processor 100 that the bus voltage 300 is less than or equal to the predetermined voltage, so that the digital signal processor 100 turns on the secondary side rectifying circuit 102 to output power.

The current protection circuit 208 comprises an over voltage protection comparator 20802 and a primary side over current protection comparator 20804. The over voltage protection comparator 20802 determines whether an input voltage is in a voltage range that the electronic components can stand or not. The primary side over current protection comparator 20804 determines whether an input current is in a current range that the electronic components can stand or not, to ensure the safety of the power supply apparatus.

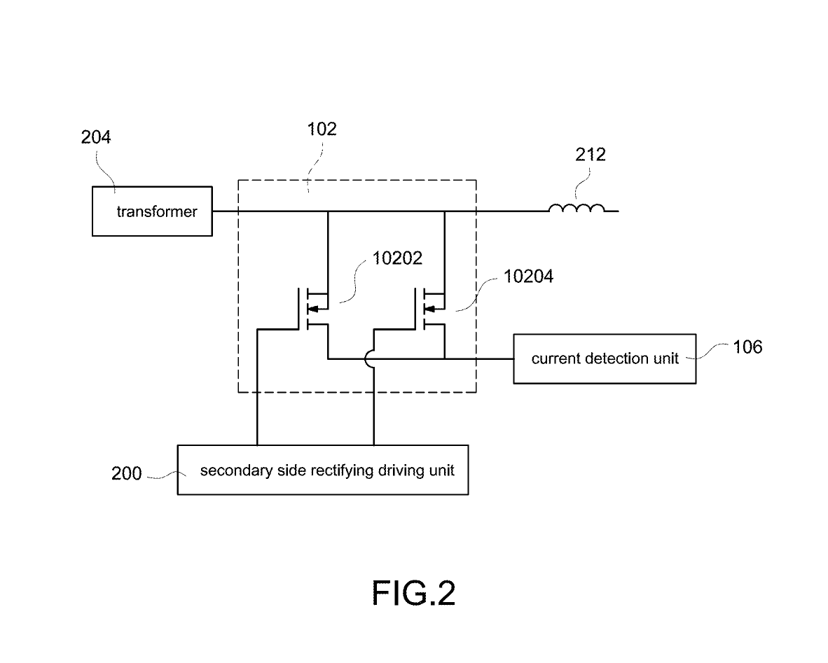

FIG. 2 shows a circuit diagram of the secondary side rectifying circuit of the power supply apparatus of the present invention. The secondary side rectifying circuit 102 comprises a first transistor switch 10202 and a second transistor switch 10204.

The first transistor switch 10202 is electrically connected to the current detection unit 106, the secondary side rectifying driving unit 200, the transformer 204 and the first inductor 212. The second transistor switch 10204 is electrically connected to the current detection unit 106, the secondary side rectifying driving unit 200, the transformer 204, the first inductor 212 and the first transistor switch 10202.

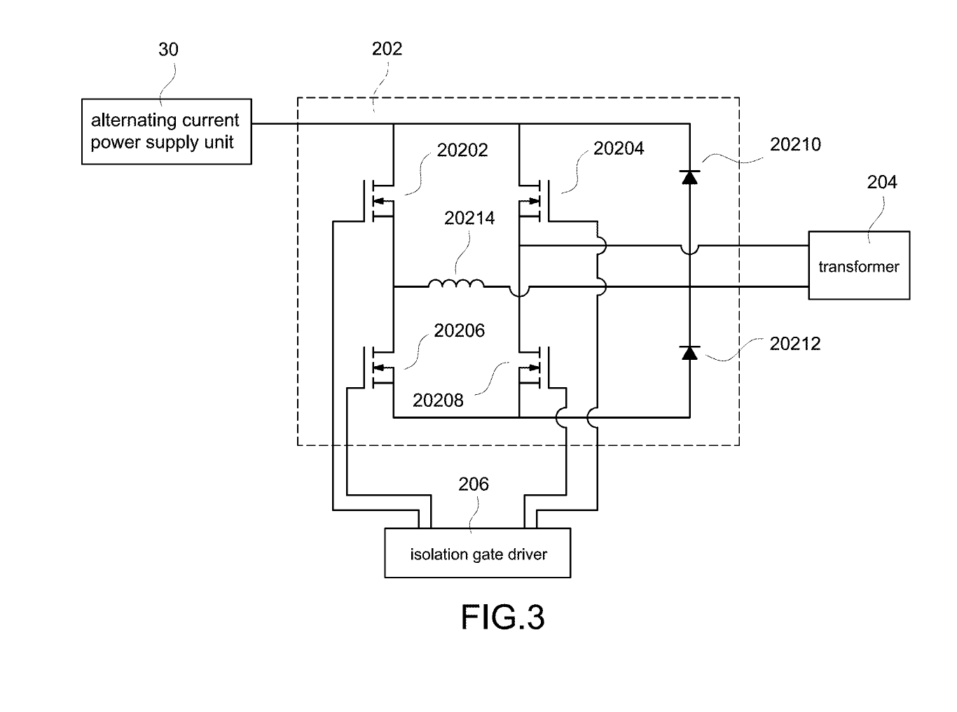

FIG. 3 shows a circuit diagram of the synchronous rectifying circuit of the power supply apparatus of the present invention. The synchronous rectifying circuit 202 comprises a third transistor switch 20202, a fourth transistor switch 20204, a fifth transistor switch 20206, a sixth transistor switch 20208, a first diode 20210, a second diode 20212 and a second inductor 20214.

The third transistor switch 20202 is electrically connected to the isolation gate driver 206. The fourth transistor switch 20204 is electrically connected to the transformer 204, the isolation gate driver 206 and the third transistor switch 20202. The fifth transistor switch 20206 is electrically connected to the isolation gate driver 206 and the third transistor switch 20202. The sixth transistor switch 20208 is electrically connected to the transformer 204, the isolation gate driver 206, the fourth transistor switch 20204 and the fifth transistor switch 20206. The first diode 20210 is electrically connected to the transformer 204, the third transistor switch 20202 and the fourth transistor switch 20204. The second diode 20212 is electrically connected to the transformer 204, the fifth transistor switch 20206, the sixth transistor switch 20208 and the first diode 20210. The second inductor 20214 is electrically connected to the transformer 204, the third transistor switch 20202, the fourth transistor switch 20204, the fifth transistor switch 20206, the sixth transistor switch 20208, the first diode 20210 and the second diode 20212.

The digital signal processor 100 sends a switching signal to the isolation gate driver 206 to drive the third transistor switch 20202, the fourth transistor switch 20204, the fifth transistor switch 20206 and the sixth transistor switch 20208. The isolation gate driver 206 amplifies the switching signal to drive the third transistor switch 20202, the fourth transistor switch 20204, the fifth transistor switch 20206 and the sixth transistor switch 20208.

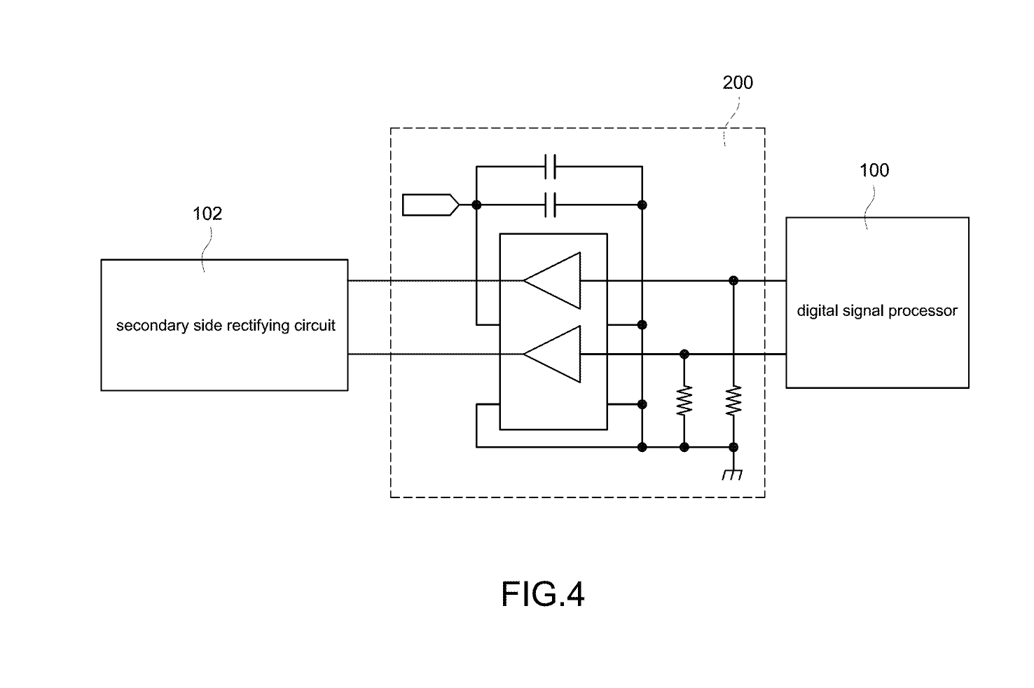

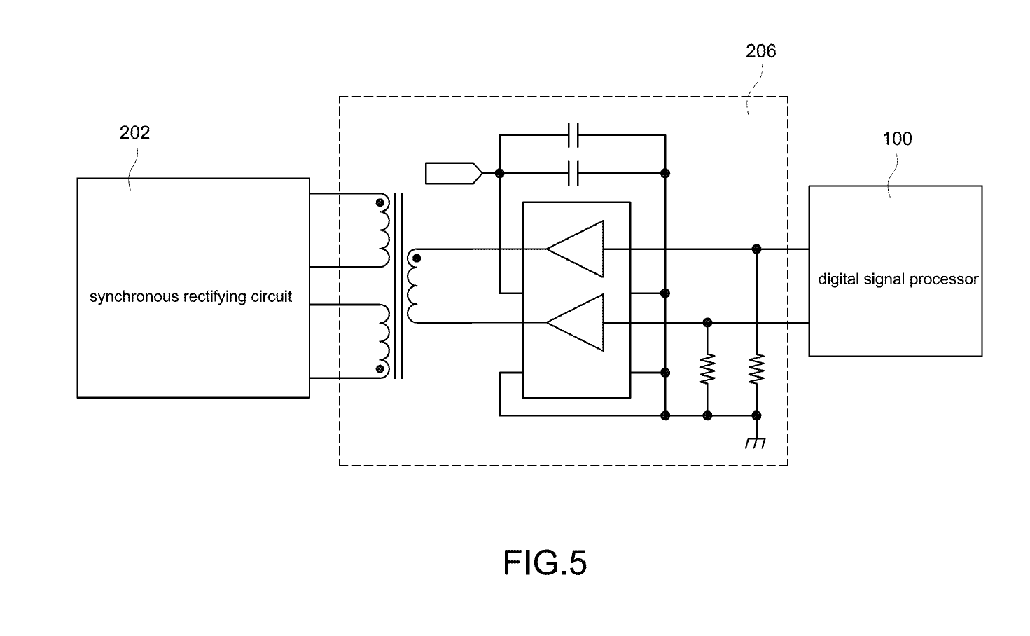

FIG. 4 shows a circuit diagram of the secondary side rectifying driving unit of the power supply apparatus of the present invention. FIG. 5 shows a circuit diagram of the isolation gate driver of the power supply apparatus of the present invention.

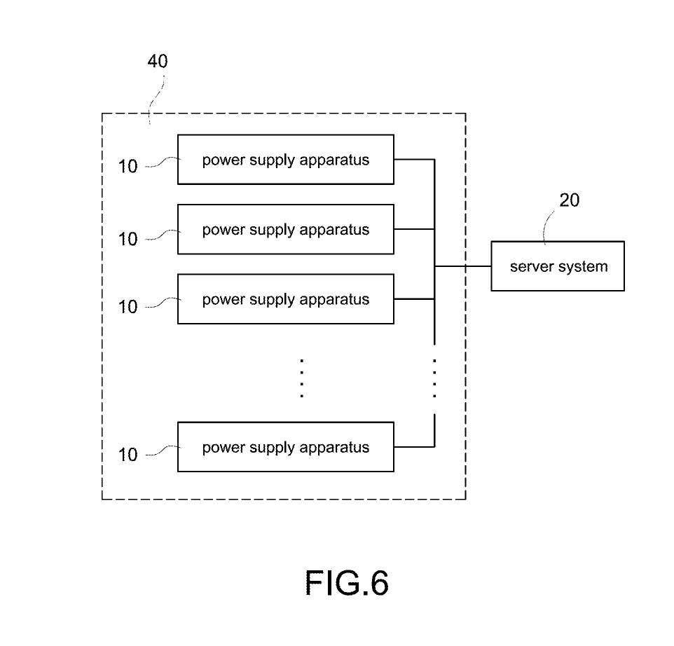

FIG. 6 shows a block diagram of an embodiment of the redundant power supply system of the present invention. Please refer to FIG. 1 at the same time. A redundant power supply system 40 comprises a plurality of power supply apparatuses 10 connected in parallel, wherein the power supply apparatus 10 is shown as FIG. 1. The power supply apparatuses 10 are electrically connected to the server system 20 and have a bus voltage and together output a direct current power.

When one of the power supply apparatuses 10 is abnormal, that means an output voltage of the power supply apparatus 10 becomes greater (namely, is increased and is greater than a predetermined output voltage), so that the bus voltage 300 is increased continuously.

When the voltage detection unit 104 of the normal power supply apparatus 10 (one or more than one) detects that the bus voltage 300 is greater than the predetermined voltage and the current detection unit 106 detects that the output current 302 is less than the predetermined current, the voltage detection unit 104 and the current detection unit 106 inform the digital signal processor 100 that the bus voltage 300 is greater than the predetermined voltage and the output current 302 is less than the predetermined current respectively, so that the digital signal processor 100 turns off the secondary side rectifying circuit 102, so that the normal power supply apparatus 10 (one or more than one) stops outputting power.

When the output voltage 301 of the abnormal power supply apparatus 10 is greater than an over voltage protection value, the voltage detection unit 104 informs the current protection circuit 208 through the digital signal processor 100, so that the current protection circuit 208 of the abnormal power supply apparatus 10 sends an over voltage protection signal to the digital signal processor 100 for over voltage protection. The digital signal processor 100 stops the abnormal power supply apparatus 10 outputting power and the bus voltage 300 is decreased. When the voltage detection unit 104 of the normal power supply apparatus 10 (one or more than one) detects that the bus voltage 300 is less than or equal to the predetermined voltage, the voltage detection unit 104 informs the digital signal processor 100 that the bus voltage 300 is less than or equal to the predetermined voltage, so that the digital signal processor 100 drives the secondary side rectifying circuit 102 through the secondary side rectifying driving unit 200, so that the normal power supply apparatus 10 (one or more than one) outputs power.

The advantage of the present invention is that when the bus voltage 300 is greater than the predetermined voltage and the output current 302 is less than the predetermined current, the digital signal processor 100 turns off the secondary side rectifying circuit 102 to stop outputting power to avoid the influence from the abnormal power supply apparatus.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A power supply apparatus with reverse current protection comprising:
a digital signal processor;
a secondary side rectifying circuit electrically connected to the digital signal processor;
a voltage detection unit electrically connected to the digital signal processor and the secondary side rectifying circuit, the voltage detection unit detecting a bus voltage; and
a current detection unit electrically connected to the digital signal processor, the secondary side rectifying circuit and the voltage detection unit,
wherein when the voltage detection unit detects that the bus voltage is greater than a predetermined voltage and the current detection unit detects that an output current is less than a predetermined current, the voltage detection unit and the current detection unit inform the digital signal processor that the bus voltage is greater than the predetermined voltage and the output current is less than the predetermined current respectively, so that the digital signal processor turns off the secondary side rectifying circuit to stop outputting power.

2. The power supply apparatus in claim 1, wherein when the voltage detection unit detects that the bus voltage is less than or equal to the predetermined voltage, the voltage detection unit informs the digital signal processor that the bus voltage is less than or equal to the predetermined voltage, so that the digital signal processor drives the secondary side rectifying circuit to output power.

3. The power supply apparatus in claim 2 further comprising:
a secondary side rectifying driving unit electrically connected to the digital signal processor and the secondary side rectifying circuit,
wherein the digital signal processor sends a first informing signal to the secondary side rectifying driving unit; after the secondary side rectifying driving unit receives the first informing signal, the secondary side rectifying driving unit controls the secondary side rectifying circuit to output power or stop outputting power.

4. The power supply apparatus in claim 3 further comprising:
a synchronous rectifying circuit;
a transformer electrically connected to the secondary side rectifying circuit and the synchronous rectifying circuit;
an isolation gate driver electrically connected to the digital signal processor and the synchronous rectifying circuit; and
a current protection circuit electrically connected to the digital signal processor.

5. The power supply apparatus in claim 4 further comprising:
a first capacitor electrically connected to the secondary side rectifying circuit, the voltage detection unit and the current detection unit; and
a first inductor electrically connected to the secondary side rectifying circuit, the voltage detection unit and the first capacitor.

6. The power supply apparatus in claim 5, wherein the secondary side rectifying circuit further comprises:
a first transistor switch electrically connected to the current detection unit, the secondary side rectifying driving unit, the transformer and the first inductor; and
a second transistor switch electrically connected to the current detection unit, the secondary side rectifying driving unit, the transformer, the first inductor and the first transistor switch.

7. The power supply apparatus in claim 6, wherein the synchronous rectifying circuit further comprises:
a third transistor switch electrically connected to the isolation gate driver;
a fourth transistor switch electrically connected to the transformer, the isolation gate driver and the third transistor switch;
a fifth transistor switch electrically connected to the isolation gate driver and the third transistor switch;
a sixth transistor switch electrically connected to the transformer, the isolation gate driver, the fourth transistor switch and the fifth transistor switch;
a first diode electrically connected to the transformer, the third transistor switch and the fourth transistor switch;
a second diode electrically connected to the transformer, the fifth transistor switch, the sixth transistor switch and the first diode; and
a second inductor electrically connected to the transformer, the third transistor switch, the fourth transistor switch, the fifth transistor switch, the sixth transistor switch, the first diode and the second diode.

8. A redundant power supply system comprising:
a plurality of power supply apparatuses with reverse current protection, the power supply apparatuses connected in parallel and having a bus voltage and together outputting a direct current power,
wherein the power supply apparatus comprises:
a digital signal processor;
a secondary side rectifying circuit electrically connected to the digital signal processor;
a voltage detection unit electrically connected to the digital signal processor and the secondary side rectifying circuit, the voltage detection unit detecting a bus voltage; and
a current detection unit electrically connected to the digital signal processor, the secondary side rectifying circuit and the voltage detection unit,
wherein when one of the power supply apparatuses is abnormal, an output voltage of the power supply apparatus becomes greater, so that the bus voltage is increased continuously;
when the voltage detection unit of the normal power supply detects that the bus voltage is greater than a predetermined voltage and the current detection unit detects that an output current is less than a predetermined current, the voltage detection unit and the current detection unit inform the digital signal processor that the bus voltage is greater than the predetermined voltage and the output current is less than the predetermined current respectively, so that the digital signal processor turns off the secondary side rectifying circuit, so that the normal power supply apparatus stops outputting power.

9. The redundant power supply system in claim 8, wherein when the output voltage of the abnormal power supply apparatus is greater than an over voltage protection value, the digital signal processor of the abnormal power supply apparatus proceeds with an over voltage protection and stops the abnormal power supply apparatus outputting power and the bus voltage is decreased; when the voltage detection unit of the normal power supply apparatus detects that the bus voltage is less than or equal to the predetermined voltage, the voltage detection unit informs the digital signal processor that the bus voltage is less than or equal to the predetermined voltage, so that the digital signal processor drives the secondary side rectifying circuit, so that the normal power supply apparatus outputs power.
